(19) United States
(12) Patent Application Publication
(10) Pub. No.: US 2026/0247133 A1
(43) Pub. Date: Aug. 20, 2026

(54) TEMPORARY IDENTIFIERS FOR DEVICES IN A GROUP

(71) Applicant: Lenovo (United States) Inc., Morrisville, NC (US)

(72) Inventors: Andreas Kunz, Ladenburg (DE); Hyung-Nam Choi, Ottobrunn (DE); Genadi Velev, Darmstadt (DE); Karthikeyan Ganesan, Kronberg Im Taunus (DE); Sheeba Backia Mary Baskaran, Friedrichsdorf (DE)

(73) Assignee: Lenovo (United States) Inc., Morrisville, NC (US)

(21) Appl. No.: 19/053,919

(22) Filed: Feb. 14, 2025

(51) Int. Cl. H04W 8/20; H04W 8/18; H04W 12/03; H04W 84/18

(52) U.S. Cl. CPC H04W 8/20; H04W 8/186; H04W 12/03; H04W 84/18

(57) ABSTRACT

Various aspects of the present disclosure relate to temporary identifiers for devices in a group. A device receives a group inventory request that includes a group identifier (ID) and a correlation ID. The device generates a temporary ID for the device based at least in part on the correlation ID and an individual ID of the device, and transmits an inventory response that includes the temporary ID for the device and the correlation ID. The device can receive a command request that includes a second temporary ID, perform, based at least in part on the second temporary ID matching the temporary ID of the device, a command indicated by the command request, and transmit a command response message that includes the second temporary ID.

### TECHNICAL FIELD

The present disclosure relates to wireless communications, and more specifically to temporary identifiers for devices in a group.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A device (e.g., a UE or Ambient Internet-of-Things (AIoT) device) for wireless communication is described. The device may be configured to, capable of, or operable to perform one or more operations as described herein. For example, the apparatus may be configured to, capable of, or operable to receive a group inventory request that includes a group identifier (ID) and a correlation ID; generate a temporary ID for the device based at least in part on the correlation ID and an individual ID of the device; and transmit an inventory response that includes the temporary ID for the device and the correlation ID.

A processor (e.g., a standalone processor chipset, or a component of a UE or of an AIoT device) for wireless communication is described. The processor may be configured to, capable of, or operable to perform one or more operations as described herein. For example, the processor may be configured to, capable of, or operable to receive a group inventory request that includes a group ID and a correlation ID; generate a temporary ID for the processor based at least in part on the correlation ID and an individual ID of the processor; and transmit an inventory response that includes the temporary ID for the processor and the correlation ID.

A method performed or performable by an apparatus (e.g., a UE or AIoT device) for wireless communication is described. The method may include receiving a group inventory request that includes a group ID and a correlation ID; generating a temporary ID for the device based at least in part on the correlation ID and an individual ID of the device; and transmitting an inventory response that includes the temporary ID for the device and the correlation ID.

In some implementations of the device, processor, and method described herein, the apparatus, processor, and method may further be configured to, capable of, performed, performable, or operable to cause the device to detect that the group ID matches a common part of the individual ID of the device, where to generate the temporary ID, the at least one processor is further configured to cause the device to generate the temporary ID based at least in part on the common part of the individual ID matching the group ID.

In some implementations of the device, processor, and method described herein, to generate the temporary ID, the apparatus, processor, and method may further be configured to, capable of, performed, performable, or operable to generate the temporary ID based at least in part on a shared security key and based at least in part on inputting the individual ID of the device and the correlation ID to a hash-based message authentication code function.

In some implementations of the device, processor, and method described herein, to generate the temporary ID, the apparatus, processor, and method may further be configured to, capable of, performed, performable, or operable to generate the temporary ID based at least in part on a shared security key and based at least in part on inputting the individual ID of the device, the correlation ID, and a common part of the individual ID of the device to a hash-based message authentication code function.

In some implementations of the device, processor, and method described herein, the shared security key is shared between the device and an AIoT function (AIoTF) that initiated the group inventory request.

In some implementations of the device, processor, and method described herein, the apparatus, processor, and method may further be configured to, capable of, performed, performable, or operable to store the temporary ID for future command paging messages.

In some implementations of the device, processor, and method described herein, to receive the group inventory request, the apparatus, processor, and method may further be configured to, capable of, performed, performable, or operable to receive the group inventory request from an AIoT reader, and to transmit the inventory response, the apparatus, processor, and method may further be configured to, capable of, performed, performable, or operable to transmit the inventory response to the AIoT reader.

In some implementations of the device, processor, and method described herein, to generate the temporary ID, the apparatus, processor, and method may further be configured to, capable of, performed, performable, or operable to receive a command request that includes a second temporary ID; perform, based at least in part on the second temporary ID matching the temporary ID of the device, a command indicated by the command request; and transmit a command response message that includes the second temporary ID.

In some implementations of the device, processor, and method described herein, the device comprises an AIoT device.

An NE (e.g., a base station) for wireless communication is described. The NE may be configured to, capable of, or operable to perform one or more operations as described herein. For example, the NE may be configured to, capable of, or operable to generate, for each of one or more devices, an expected temporary ID for the device based at least in part on a correlation ID and an individual ID of the device; transmit a group inventory request that includes a group ID and a correlation ID; and receive an inventory response that includes a temporary ID for the device and the correlation ID.

A processor (e.g., a standalone processor chipset, or a component of a NE (e.g., a base station)) for wireless communication is described. The processor may be configured to, capable of, or operable to perform one or more operations as described herein. For example, the processor may be configured to, capable of, or operable to generate, for each of one or more devices, an expected temporary ID for the device based at least in part on a correlation ID and an individual ID of the device; transmit a group inventory request that includes a group ID and a correlation ID; and receive an inventory response that includes a temporary ID for the device and the correlation ID.

A method performed or performable by an NE (e.g., a base station) for wireless communication is described. The method may include generating, for each of one or more devices, an expected temporary ID for the device based at least in part on a correlation ID and an individual ID of the device; transmitting a group inventory request that includes a group ID and a correlation ID; and receiving an inventory response that includes a temporary ID for the device and the correlation ID.

In some implementations of the NE, processor, and method described herein, the NE, processor, and method may further be configured to, capable of, performed, performable, or operable to detect that an individual device of the one or more devices responded to the group inventory request based at least in part on a received temporary ID matching the expected temporary ID for the individual device.

In some implementations of the NE, processor, and method described herein, the NE, processor, and method may further be configured to, capable of, performed, performable, or operable to, for each of the one or more devices, generate the expected temporary ID for the device based at least in part on a common part of the individual ID matching the group ID.

In some implementations of the NE, processor, and method described herein, to generate the expected temporary ID, the NE, processor, and method may further be configured to, capable of, performed, performable, or operable to generate the expected temporary ID based at least in part on a shared security key and based at least in part on inputting the individual ID of the device and the correlation ID to a hash-based message authentication code function.

In some implementations of the NE, processor, and method described herein, to generate the expected temporary ID, the NE, processor, and method may further be configured to, capable of, performed, performable, or operable to generate the expected temporary ID based at least in part on a shared security key and based at least in part on inputting the individual ID of the device, and the correlation ID, and a common part of the individual ID of the device matching the group ID to a hash-based message authentication code function.

In some implementations of the NE, processor, and method described herein, different shared security keys are shared between the NE and different ones of the one or more devices.

In some implementations of the NE, processor, and method described herein, to transmit the group inventory request, the NE, processor, and method may further be configured to, capable of, performed, performable, or operable to transmit the group inventory request to an AIoT reader, and to receive the inventory response, the NE, processor, and method may further be configured to, capable of, performed, performable, or operable to receive the inventory response from the AIoT reader.

In some implementations of the NE, processor, and method described herein, the NE, processor, and method may further be configured to, capable of, performed, performable, or operable to select a temporary ID of one device of the one or more devices; transmit a command request that includes the temporary ID of the one device; and receive a command response message that includes the temporary ID of the one device.

In some implementations of the NE, processor, and method described herein, each of the one or more devices comprises an AIoT device.

In some implementations of the NE, processor, and method described herein, the NE comprises an AIoTF.

### BRIEF DESCRIPTION OF THE DRAWINGS

FIG. 1 illustrates an example of a wireless communications system in accordance with aspects of the present disclosure.

FIG. 2 illustrates an example of an AIoT system in accordance with aspects of the present disclosure.

FIG. 3 illustrates an example of an operator allocated ID in accordance with aspects of the present disclosure.

FIG. 4 illustrates an example of a third party allocated ID in accordance with aspects of the present disclosure.

FIG. 5 illustrates an example of an AIoT ID in accordance with aspects of the present disclosure.

FIG. 6 illustrates an example structure of the AIoT ID in accordance with aspects of the present disclosure.

FIG. 7 illustrates an example of generating a temporary ID in accordance with aspects of the present disclosure.

FIG. 8 illustrates an example of generating a temporary ID using a hash function in accordance with aspects of the present disclosure.

FIG. 9 illustrates an example of generating a temporary ID in accordance with aspects of the present disclosure.

FIG. 10 illustrates an example of generating a temporary ID using a hash function in accordance with aspects of the present disclosure.

FIG. 11 illustrates an example of a group inventory procedure in accordance with aspects of the present disclosure.

FIG. 12 illustrates an example of an individual command procedure in accordance with aspects of the present disclosure.

FIG. 13 illustrates an example of a device in accordance with aspects of the present disclosure.

FIG. 14 illustrates an example of a processor in accordance with aspects of the present disclosure.

FIG. 15 illustrates an example of a NE in accordance with aspects of the present disclosure.

FIGS. 16 and 17 illustrate flowcharts of methods performed by a device in accordance with aspects of the present disclosure.

FIGS. 18 and 19 illustrate flowcharts of methods performed by a NE in accordance with aspects of the present disclosure.

### DETAILED DESCRIPTION

An AIoT device refers to a low-power (e.g., self-powered) sensor or device, which is typically small and/or low-cost. AIoT devices are battery-less or have limited energy storage capability (e.g., using a capacitor) and the energy for the AIoT devices is provided through the harvesting of radio waves, light, motion, heat, or any other power source that could be seen suitable. Additionally, due to the expectation of low complexity, maintenance free and long life span (e.g., more than 10 years), small size and lower capabilities and lower power consumption than previously defined 3rd generation partnership project (3GPP) Internet of Things (IoT) devices (e.g., narrowband IoT (NB-IoT) or enhanced machine type communication (eMTC) devices), it is assumed that AIoT devices do not have a universal subscriber identity module (USIM) as a normal 3GPP defined UE but still are expected to have some certain level of security for communication.

One example of an AIoT device is a device (e.g., referred to as a passive device) that has no energy storage, no independent signal generation, and uses backscattering transmission. Another example of an AIoT device is a device (e.g., referred to as a semi-passive device) that has energy storage, no independent signal generation, and uses backscattering transmission. Use of stored energy can include amplification for reflected signals. Another example of an AIoT device is a device (e.g., referred to as an active device) that has energy storage, has independent signal generation (e.g., an active RF component for transmission), and may use backscattering transmission. For example, AIoT devices may include an energy harvester with an output power of from 1 microwatt (μW) to a few hundreds of μW. There are different topologies and deployment scenarios of AIoT. Examples of these topologies include a topology where a base station acts as reader and as source of a carrier wave, a topology where the base station acts as a reader but another device is used as a source of the carrier wave, a topology where the base station acts as a controller and another intermediate node is used as a reader and as a source of the carrier wave, and so forth.

One usage scenario for AIoT devices involves communication with multiple different AIoT devices, such as an indoor factory or warehouse area where AIoT devices are attached to items (e.g., products, boxes, pallets) being tracked, an office or factory where AIoT devices provide sensor data (e.g., temperature, humidity, noise level, light level), and the like. Two scenarios of communication towards the AIoT device are considered: an inventory request and a command request. An inventory request can be communicated (e.g., sent, transmitted) to an individual AIoT device that responds to the inventory request, or to a group of AIoT devices and all AIoT devices that receive the inventory request respond to the inventory request. A command request can be sent, transmitted, or communicated to an individual AIoT device and is performed after an inventory procedure (inventory request and response(s)) has been performed. A command request includes or identifies a command or operation, such as a read operation (e.g., to receive, retrieve, or obtain data or other information from the AIoT device), a write operation (e.g., to transmit, send, or provide data or other information to the AIoT device), a deactivate operation (e.g., to turn off or disable functionality of the AIoT device), an activate operation (e.g., to turn on or enable functionality of the AIoT device), and the like.

A group request (e.g., an inventory request) can be defined or identified by using a first sequence in a portion of the individual AIoT device IDs. It is expected that a predefined portion or part of the individual AIoT device IDs (also referred to as private AIoT device IDs) is common to different groups of AIoT devices and that the individual AIoT device IDs differ in one or more other portions or parts. One issue with group requests is privacy or protecting the privacy of the individual AIoT device IDs. Accordingly, a problem is how to allocate an individual AIoT device a unique (within a group of AIoT devices) temporary ID during a group inventory procedure, which is subject to be received by a large group of AIoT devices, so that the individual AIoT device IDs remain private (e.g., secret, not visible or accessible to other AIoT devices in the group). The techniques discussed herein describe a unique (e.g., within the group of AIoT devices) temporary ID for an AIoT device that provides privacy for the AIoT device when the AIoT device is paged for an individual command message following a group inventory procedure.

Using the techniques described herein, a group inventory request includes a group ID and a correlation ID. The group ID identifies a group of AIoT devices that are to respond to the group inventory request, and the correlation ID identifies a particular group inventory request. Using different correlation IDs for different group inventory requests allows the different group inventory requests to be tracked. When an AIoT device receives a group inventory request and the AIoT device detects that it is part of the group, the AIoT device uses certain parts of the individual ID of the AIoT device and a shared security key, as well as a correlation ID from the group inventory request to compute an individual temporary ID for the AIoT device. The AIoT device sends, communicates, or transmits, to an AIoT function (AIoTF) an inventory response to the group inventory request. The AIoTF performs the same computation for each expected AIoT device of the group and can as a following request address the individual AIoT devices with their temporary IDs in a command request.

Each individual ID of an AIoT device includes a common part that is common to multiple AIoT devices (e.g., a portion of which is used to identify different groups of AIoT devices) and a non-common or individual part that is specific to a single AIoT device. In one or more implementations, the derivation of the temporary ID for the AIoT device is performed as a keyed hash-based message authentication code (HMAC) with the shared security key and the inputs of the remaining part(s) of the common part that is not used to identify groups of AIoT devices, the correlation ID and the individual ID of the AIoT device. Additionally, or alternatively, the derivation of the temporary ID of the AIoT device is performed as a keyed HMAC with one or both of the correlation ID or the individual ID of the AIoT device.

By using temporary IDs as discussed herein, the AIoTF is able to send an inventory request to a group of AIoT devices but target or identify individual AIoT devices for subsequent command requests without revealing the individual IDs of the AIoT devices targeted or identified by the command requests to the other AIoT devices in the group. With different group inventory requests having different correlation IDs, the temporary IDs can be updated with each group inventory request, providing additional privacy for the individual IDs of the AIoT devices by preventing other AIoT devices in the group from tracking temporary IDs for the AIoT devices across multiple group inventory requests.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

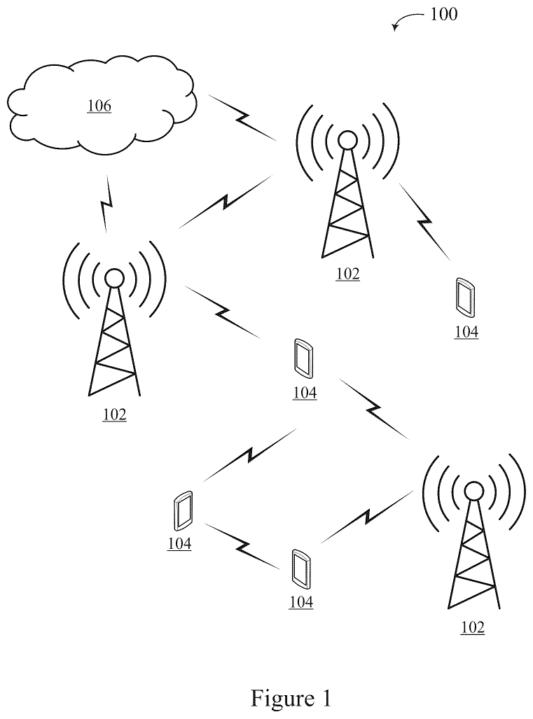

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an AIoT device, an IoT device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A group inventory request can be transmitted by a NE 102 to one or more UEs 104 (e.g., one or more AIoT devices). The group inventory request includes a group ID that identifies a group of UEs 104 devices and a correlation ID that identifies a particular group inventory request. In response to a group inventory request for a group that the UE 104 is part, the UE 104 uses parts of an individual ID of the UE 104 and a shared security key, as well as the correlation ID, to compute an individual temporary ID for the UE 104 device. The UE 104 responds to the group inventory request with an inventory response, and can subsequently receive one or more additional requests (e.g., command requests) identifying the UE 104 with the temporary ID for the UE 104.

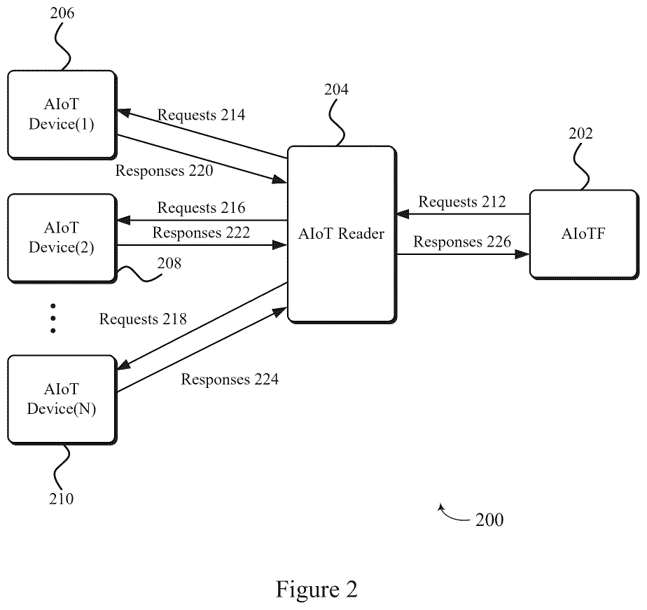

FIG. 2 illustrates an example of an AIoT system 200 in accordance with aspects of the present disclosure. The AIoT system 200 includes an AIoTF 202, an AIoT reader 204, and multiple (N) AIoT devices 206, 208, . . . , 210. The AIoTF 202 initiates one or more requests (e.g., inventory requests or command requests) targeting the AIoT devices 206, 208, . . . , 210, and takes various actions based on responses received from the AIoT devices 206, 208, . . . , 210. Initiating a request refers to beginning or starting a request. The AIoTF 202 can be part of, for example, a NE 102 (e.g., a base station) or a function in the CN 106. The AIoTF 202 transmits requests 212 to the AIoT reader 204, which in turn transmits requests 214, 216, . . . , 218 to the AIoT devices 206, 208, . . . , 210, respectively. The AIoT reader 204 is a device within communication range of the AIoT devices 206, 208, . . . , 210 that can transmit, send, or communicate data or instructions to the AIoT devices 206, 208, . . . , 210 and can receive, obtain, or communicate data or instructions from the AIoT devices 206, 208, . . . , 210. The requests 212 as well as the requests 214, 216, . . . , 218 can be individual requests or group requests. An individual request targets or identifies a single one of the AIoT devices 206, 208, . . . , 210, whereas a group request targets or identifies a set of multiple AIoT devices 206, 208, . . . , 210. Sending a request (e.g., requests 212, 214, 216, . . . , 218) is also referred to as paging one or more AIoT devices. The AIoT devices 206, 208, . . . , 210 transmit responses 220, 222, . . . , 224, respectively, to the AIoT reader 204, which returns the responses 220, 222, . . . , 224 to the AIoTF 202 as responses 226.

Each response 220, 222, . . . , 224 includes a temporary ID for the corresponding AIoT devices 206, 208, . . . , 210, respectively, that transmitted, sent, or communicated the response. A temporary ID refers to a short-term use (e.g., used for a single correlation ID) identifier of the AIoT device that is generated based at least in part on an individual ID of the AIoT device and a correlation ID transmitted, communicated, or sent by the AIoTF 202 and/or AIoT reader 204. The use of the temporary ID for an AIoT device 206, 208, or 210 provides privacy protection of messages between the AIoT device 206, 208, or 210 and the AIoTF. For each of the AIoT devices 206, 208, . . . , 210, the AIoT device itself and the AIoTF 202 are configured with the individual ID of the AIoT device as well as a shared security key so that, given a correlation ID, both the AIoT device and the AIoTF 202 are able to generate the same temporary ID for the AIoT device. A correlation ID refers to an ID of a set of one or more procedures, such as an inventory procedure (e.g., group inventory request and inventory responses) and one or more command procedures (e.g., command request and command response). Different correlation IDs allow the AIoTF 202 to keep track of which AIoT devices 206, 208, . . . , 210 have responded to which sets of one or more procedures.

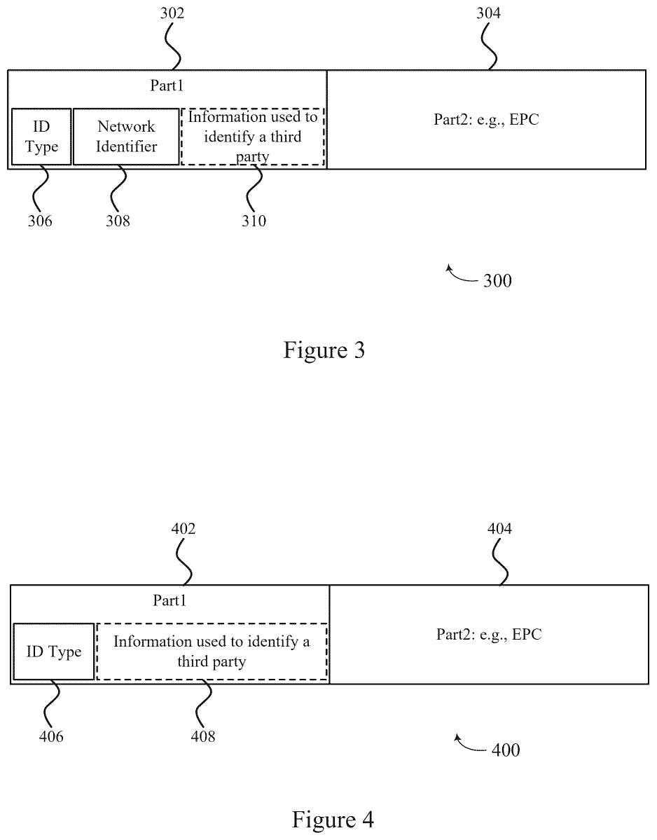

FIG. 3 illustrates an example of an operator allocated ID 300 in accordance with aspects of the present disclosure. The operator allocated ID 300 includes a first part 302 (part 1) and a second part 304 (part 2). The first part 302 includes an ID type 306, a network identifier 308, and information 310. The ID type 306 indicates that the operator allocated ID 300 is an operator allocated ID (e.g., rather than a third party allocated ID, such as an ID allocated by a company using the AIoT device or that manufactured the AIoT device). The network identifier 308 identifies the operator network (e.g., the mobile country code (MCC) and the mobile network code (MNC) of the operator network. The information 310 is information used to identify a third party.

The second part 304 includes an individual identifier of the operator allocated ID 300. This operator allocated ID 300 is, for example, unique (e.g., within the group of AIoT devices) to the AIoT device that has the operator allocated ID 300.

As discussed in more detail below, a temporary ID of an AIoT device can be generated using or based on the operator allocated ID 300, including generating individually a unique (e.g., within a group of AIoT devices) temporary ID for all AIoT devices in the group in scenarios where a large number of devices are paged with a shorter group ID.

FIG. 4 illustrates an example of a third party allocated ID 400 in accordance with aspects of the present disclosure. The third party allocated ID 400 includes a first part 402 (part 1) and a second part 404 (part 2). The first part 402 includes an ID type 406 and information 408. The ID type 406 indicates that the third party allocated ID 400 is a third party allocated ID (e.g., rather than an operator allocated ID). The information 408 is information used to identify the third party that allocated the third party allocated ID 400.

The second part 404 includes an individual identifier of the third party allocated ID 400. This third party allocated ID 400 is, for example, unique (e.g., within the group of AIoT devices) to the AIoT device that has the third party allocated ID 400.

As discussed in more detail below, a temporary ID of an AIoT device can be generated using or based on the third party allocated ID 400, including generating individually a unique (e.g., within a group of AIoT devices) temporary ID for all AIoT devices in the group in scenarios where a large number of devices are paged with a shorter group ID.

Referring to the operator allocated ID 300 of FIG. 3 and/or the third party allocated ID 400 of FIG. 4, a group request is defined just by using a first sequence of dynamic length of the Part2 (the second part 304 or second part 404) of the AIoT device IDs. It is assumed that a predefined part of the Part2 (the second part 304 or second part 404) is common to the AIoT devices and the IDs differ only in the latter part. The operator or third party is able to control the size of the group depending on the length of the common Part2 (the second part 304 or second part 404) that is used. E.g., if a shorter common Part2 (the second part 304 or second part 404) is used as the group ID, then more devices have the same common part as if a larger common Part2 (the second part 304 or second part 404) were selected.

The techniques discussed herein describe how to allocate an individual AIoT device a unique (e.g., within a group of AIoT devices) temporary ID during a group Inventory procedure, which is subject to be received by a large group of devices. The unique (e.g., within the group of AIoT devices) temporary identity provides privacy for the AIoT device when the AIoT device is paged for an individual command message (following the group inventory paging).

Returning to FIG. 2, as discussed above the AIoT devices 206, 208, . . . , 210 may not have a USIM as a normal 3GPP defined UE. Accordingly, the AIoT devices 206, 208, . . . , 210 cannot rely on a USIM as a main basis for the security and for the confidentiality and integrity protection of the individual ID of the AIoT devices 206, 208, . . . , 210. Further, as discussed above, the AIoT devices 206, 208, . . . , 210 are expected to have limited energy storage capability, small size, and be maintenance free with a long life span. Accordingly, the AIoT devices 206, 208, . . . , 210 cannot rely on techniques where the size of the device, including the battery size for a long-lasting operation, does not matter much.

The techniques discussed herein use a secret parameter known to the device and an AIoTF, but not known to other devices, as a basis for a keyed hash function to compute a temporary ID based on the private ID of the device (also referred to as an individual ID of the device) and other input parameters. The secret parameter can be the private ID of the device, or a unique (e.g., within a group of AIoT devices) string or random number. In the following the secret parameter is referred to as a shared security key.

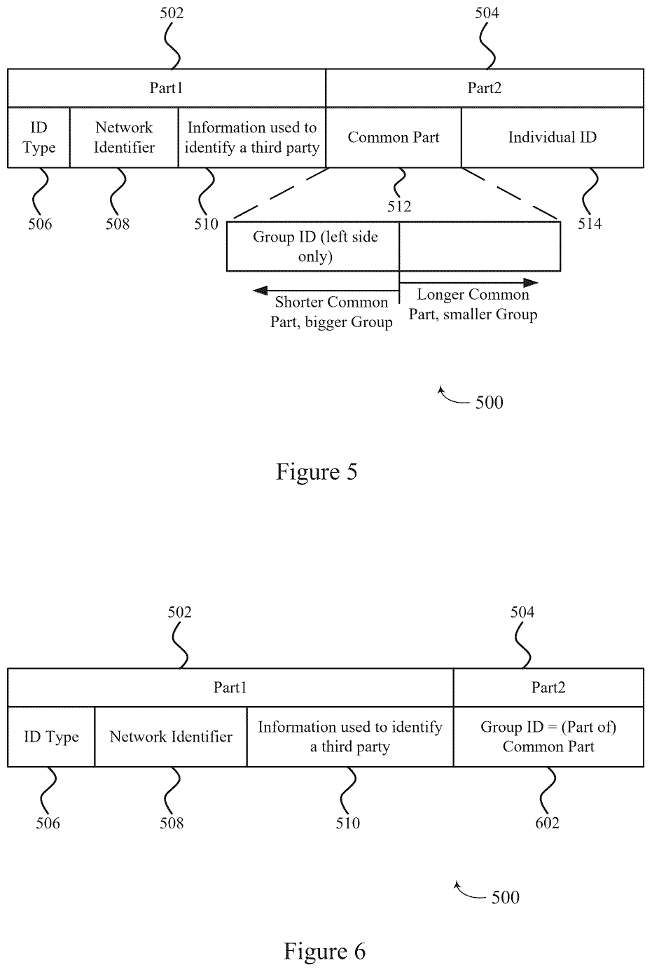

FIG. 5 illustrates an example of an AIoT ID 500 in accordance with aspects of the present disclosure. FIG. 5 illustrates an example structure of the AIoT identity and the relationship to the group ID. The operator allocated ID 500 includes a first part 502 (part 1) and a second part 504 (part 2). The first part 502 includes an ID type 506, a network identifier 508, and information 510. Analogous to FIG. 3, the ID type 506 indicates that the operator allocated ID 500 is an operator allocated ID (e.g., rather than a third party allocated ID). The network identifier 508 identifies the operator network (e.g., the MCC and the MNC of the operator network. The information 510 is information used to identify a third party.

The second part 504 is split into two sub-parts: a common part 512, which is the same value for all the AIoT devices (e.g., of a specific vendor), and an individual ID sub-part 514 (which may also be referred to as a private ID part). The second part 504 is a unique (e.g., within a group of AIoT devices), typically permanent (e.g., for the lifetime of the AIoT device) identifier of the AIoT device. The common part 512 can be used as a group identifier.

FIG. 6 illustrates an example structure of the AIoT ID 500 in accordance with aspects of the present disclosure. The AIoT ID 500 includes the first part 502 (part 1) and the second part 504 (part 2). The first part 502 includes the ID type 506, the network identifier 508, and the information 510. As illustrated, part of the second part 504 is used as a group ID 602.

Returning to FIG. 5, the least number of AIoT devices are paged if the whole common part 512 is used as a group ID. If only a few digits of the common part 512 are used as a group ID, then a large number of AIoT devices are paged, because they all have the same few digits in common.

When the AIoTF is performing an inventory request, the inventory request can be targeted against a single device or a group of devices. If the inventory request targets a group of devices, a sub-part of the common part 512 is used as a group ID, depending on the number of devices the AIoTF wants to page. The rest of the common part 512 and the individual identifier sub-part 514 are not included in the group ID.

In one or more implementations, a correlation ID is used to identify all the responses that belong to the same inventory request. For example, if a group of devices with, e.g., Group ID #123 is paged, then the inventory request message includes, e.g., a correlation ID #5 which all responding AIoT devices that belong to the group ID #123 will include in their responses so that the AIoT reader and the AIoTF can correlate all the responses to the inventory paging message.

For ID privacy, it is desirable that the individual ID sub-part 514, i.e., the private identifier, is not used in a paging message for an individual request message, following the group inventory request. Instead, a temporary ID is used to preserve the privacy of the AIoT device.

The techniques discussed herein generate a temporary ID in the AIoT device and in the AIoTF individually based on the shared security key. The AIoT device uses the temporary ID in the response to the inventory group request. In that way, all the AIoT devices respond with an individual temporary ID and with the same correlation ID so that they belong to or correspond to the same paging message (e.g., the same group inventory request). For a following command procedure, the AIoTF uses the temporary IDs to address the individual devices without revealing the private device ID (in the individual ID sub-part 514). The temporary ID is then refreshed with the next inventory request.

It is expected that the correlation ID will change for each group paging, else the AIoT reader and the AIoTF cannot correlate all the responses from the AIoT devices to the same paging message. Thus, the correlation ID is used here as a freshness parameter in the derivation of the temporary ID.

Furthermore, it is assumed that at least the shared security key and the AIoT device ID are preconfigured in the AIoT device and known in the AIoTF. The AIoTF may receive this information from various sources, such as from a database (e.g., an operator database) or a third party application server/function (AS/AF), or from an authentication, authorization and accounting (AAA) server.

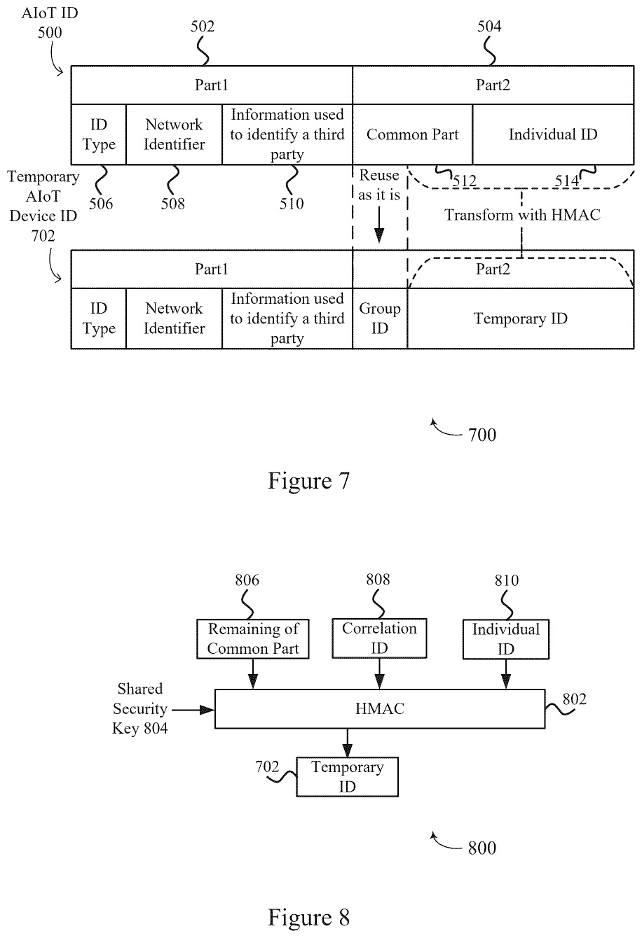

FIG. 7 illustrates an example 700 of generating a temporary ID in accordance with aspects of the present disclosure. In the example 700, the temporary AIoT device ID 702 of the AIoT device is derived in part from the AIoT ID 500 and includes the remaining part of the common part 512 that is not used as the group ID in the derivation of the temporary AIoT device ID 702 together with the correlation ID and the individual ID (the private device ID).

FIG. 8 illustrates an example 800 of generating a temporary ID using a hash function in accordance with aspects of the present disclosure. The derivation of the temporary AIoT device ID 702 of FIG. 7 is performed as a keyed HMAC function 802 with the shared security key 804 and the inputs of the remaining part 806 of the common part 512 of the AIoT device ID 702 that does not belong to the group ID, the correlation ID 808, and the individual ID 810 (the private ID) from the individual ID sub-part 514.

Additionally, or alternatively, more of the common part 512 can be used as an input to the HMAC function 802. For example, some or all of the common part 512 that does belong to the group ID can be used in in place of the remaining part 806.

Additionally, or alternatively, any other parameters that are known to the AIoTF and the AIoT device can be used as inputs to the HMAC function 802. For example, an ID of the AIoTF can be used as an input to the HMAC function 802 to generate the temporary AIoT device ID 702.

The output of the HMAC function 802 has a fixed length, depending on the function used. If the output is too long to fit into the space of the second part 504 (Part2), then the output can be truncated (e.g., at the most or the least significant bits) so that the output fits into the size of the second part 504.

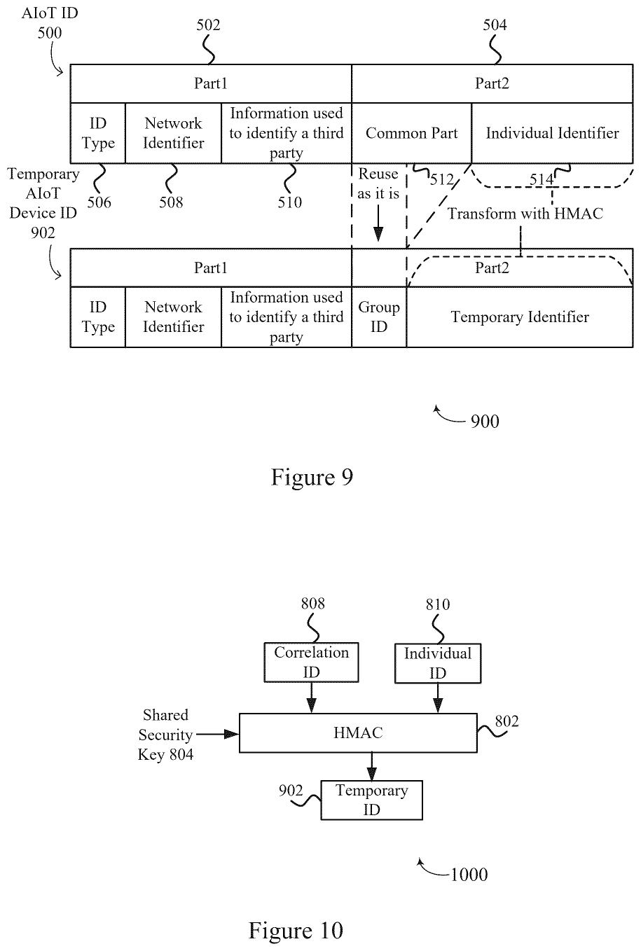

FIG. 9 illustrates an example 900 of generating a temporary ID in accordance with aspects of the present disclosure. In the example 900, the temporary AIoT device ID 902 is based on the correlation ID and the individual ID (the private device ID) but is not based on any portion of the common part 512. As illustrated in the example 900, the remaining part of the common part 512 that does not belong to the group ID is not used as input and is discarded for the computation of the temporary ID 902.

FIG. 10 illustrates an example 1000 of generating a temporary ID using a hash function in accordance with aspects of the present disclosure. The derivation of the temporary AIoT device ID 902 is performed as a keyed HMAC function with the shared security key 804 and the inputs of the correlation ID 808 and the individual ID 810 (the private ID) from the individual sub-part 514.

Additionally, or alternatively, any other parameters that are known to the AIoTF and the AIoT device can be used as inputs to the HMAC function 802. For example, an ID of the AIoTF can be used as an input to the HMAC function 802 to generate the temporary AIoT device ID 902.

The output of the HMAC function 802 in FIG. 10 has a fixed length, depending on the function used. If the output is too long to fit into the space of the second part 504 (Part2), then the output can be truncated (e.g., at the most or the least significant bits) so that the output fits into the size of the second part 504.

Additionally, or alternatively, the temporary AIoT device ID 902 is generated based on the correlation ID 808 and the individual ID 810 may not be input to the HMAC function 802. Since the correlation ID is changing with each group inventory request, and the shared security key 804 is different for different AIoT devices, the temporary AIoT device ID 902 still uniquely (e.g., within the group of AIoT devices) identifies the specific AIoT device.

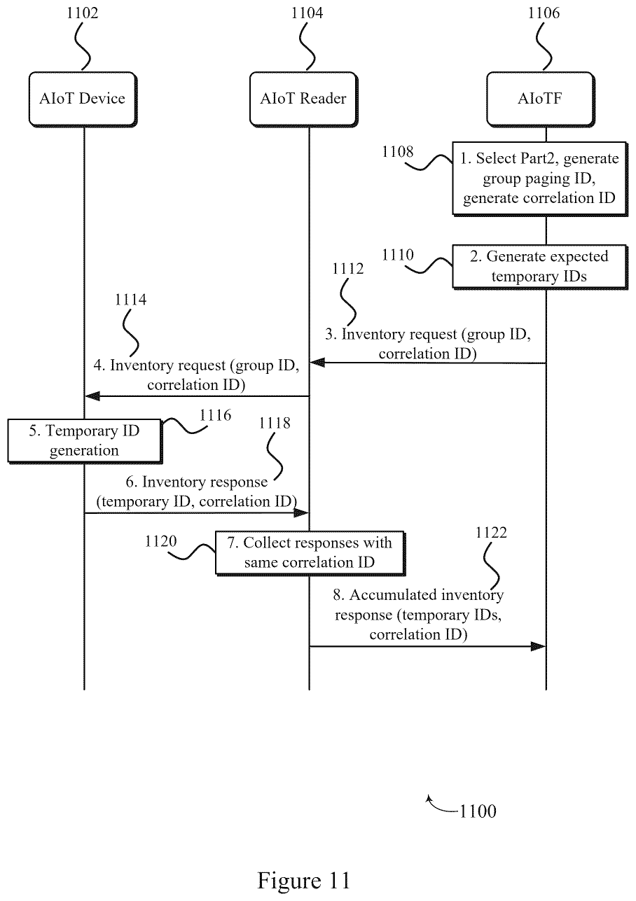

FIG. 11 illustrates an example of a group inventory procedure 1100 in accordance with aspects of the present disclosure. In the group inventory procedure 1100, a group inventory request is paging a group (e.g., a large group) of AIoT devices, depending on the length of the common part that is used as the group ID 602 (in the second part 504 (Part2) of the AIoT device ID 500 structure discussed above, e.g., with respect to FIG. 6).

The group inventory procedure 1100 discussed with reference to an AIoT device 1102, an AIoT reader 1104, and an AIoTF 1106. The AIoT device 1102 is, for example, an AIoT device 206, 208, or 210 of FIG. 2. The AIoT reader 1104 is, for example, an AIoT reader 204 of FIG. 2. The AIoTF 1106 is, for example, an AIoTF 202 of FIG. 2.

At 1108 (e.g., step 1), the AIoTF 1106 initiates, starts, or begins an inventory procedure. The AIoTF 1106 may perform step 1 based on a service request received from an application function (AF) or based on one or more other triggers. The service request includes, e.g., a service request type set to “inventory” and a list of AIoT device individual IDs. The AIoTF 1106 selects the common part of Part2 (e.g., part of the second part 504 discussed above) and creates a group ID (e.g., group ID 602 of FIG. 6). For example, the AIoTF 1106 selects the length of the common part (e.g., common part 512 of FIG. 5) and implicitly the size of the group of devices that have the group ID in common in their second part 504 (Part2) of the AIoT device ID 500 structure. The AIoTF generates a fresh (e.g., a new) correlation ID that is used to correlate all the responses from the AIoT devices to the paging message (the inventory request).

At 1110 (e.g., step 2), the AIoTF 1106 generates expected temporary IDs for the AIoT devices. Additionally, or alternatively, the expected temporary IDs for the AIoT devices may be generated at other times. The AIoTF 1106 may generate, for each AIoT device that is expected to respond to the paging message, the individual temporary ID as discussed above (e.g., using a shared-key based HMAC as discussed above with reference to FIG. 8 or FIG. 10). If the expected temporary IDs are generated at this point in time, the AIoTF 1106 can check later more easily which AIoT devices responded to the inventory request and which AIoT devices did not respond to the inventory request.

At 1112 (e.g., step 3), the AIoTF 1106 communicates (e.g., transmits, sends, outputs, forwards) the group inventory request to the AIoT reader 1104, including the group ID and the correlation ID. This group inventory request may also be referred to as a message or group inventory request message.

At 1114 (e.g., step 4), the AIoT reader 1104 communicates (e.g., transmits, sends, outputs, forwards) the group inventory request, including the group ID and the correlation ID, to the AIoT devices, including AIoT device 1102. This sending of the group inventory request may also be referred to as paging the AIoT device 1102, sending a message to the AIoT device 1102, sending a paging message to the AIoT device 1102, and the like.

At 1116 (e.g., step 5), the AIoT devices identified by the group inventory request respond. The AIoT devices, including AIoT device 1102, that have the group ID in common with their common part of Part2 (e.g., part of the second part 504 discussed above) create a temporary ID (e.g., using a shared-key based HMAC as discussed above with reference to FIG. 8 or FIG. 10). The AIoTF may store the temporary ID for further individual paging, e.g., in case of a following command procedure.

At 1118 (e.g., step 6), the AIoT device 1102 responds to the group inventory paging, communicating (e.g., transmitting, sending, outputting, forwarding) an inventory response message that includes the temporary ID computed by the AIoT device 1102 and the correlation ID.

At 1120 (e.g., step 7), the AIoT reader 1104 communicates (e.g., receives, retrieves, obtains, collects) the response from the AIoT device 1102 and responses from any other AIoT devices with the same correlation ID.

At 1122 (e.g., step 8), the AIoT reader 1104 communicates (e.g., transmits, sends, outputs, forwards) to the AIoTF 1106 an accumulated group inventory response with the temporary IDs of all responses with the same correlation ID. The AIoTF 1106 can then check, based on the temporary IDs generated at 1110, which of the AIoT devices responded to the group paging. Additionally, or alternatively, the AIoT reader 1104 can communicate (e.g., transmit, send, output, forward) the group inventory responses to the AIoTF individually (as they are received) rather than as an accumulated group inventory response.

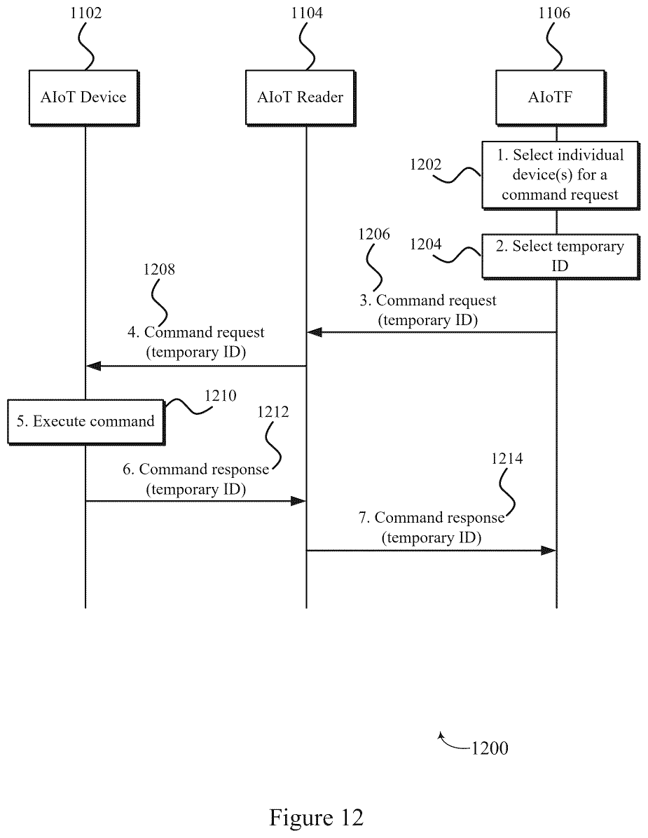

FIG. 12 illustrates an example of an individual command procedure 1200 in accordance with aspects of the present disclosure. In the individual command procedure 1200, the command procedure is carried out per individual AIoT device and uses the temporary ID for the paging message which carries the command content. The individual command procedure 1200 is discussed with reference to the AIoT device 1102, the AIoT reader 1104, and the AIoTF 1106 of FIG. 11.

At 1202 (e.g., step 1), the AIoTF 1106, which previously carried out a group inventory procedure (e.g., group inventory procedure 1100 of FIG. 11), knows which of the AIoT devices are available based on the received temporary IDs. The AIoTF 1106 can initiate, start, or begin a command procedure for select one or more individual devices for a command request. A command procedure includes communicating (e.g., transmitting, sending, outputting, forwarding) a command request that includes or identifies a command or operation, such as a read operation (e.g., to receive, retrieve, or obtain data or other information from the AIoT device), a write operation (e.g., to transmit, send, or provide data or other information to the AIoT device), a deactivate operation (e.g., to turn off or disable functionality of the AIoT device), an activate operation (e.g., to turn on or enable functionality of the AIoT device), and the like

At 1204 (e.g., step 2), the AIoTF 1106 selects an individual temporary ID for a command procedure.

At 1206 (e.g., step 3), the AIoTF 1106 communicates (e.g., receives, retrieves, obtains, collects) the command request to the AIoT reader, including the temporary ID and a command type. The command type can be, for example, a parameter of the command request, or can be inherent in the command request itself (e.g., a write command, a read command, and so forth.

At 1208 (e.g., step 4), the AIoT reader 1104 communicates (e.g., transmits, sends, outputs, forwards) the command request to the AIoT device 1102, including the temporary ID and command type. This sending of the group inventory request may also be referred to as paging the AIoT device 1102, sending a message to the AIoT device 1102, sending a paging message to the AIoT device 1102, and the like.

At 1210 (e.g., step 5), the AIoT device 1102 that has the same temporary ID as the command request performs the requested action of the command procedure.

At 1212 (e.g., step 6), the AIoT device 1102 responds to the command request by communicating (e.g., transmitting, sending, outputting, forwarding) to the AIoT reader 1104 a command response that includes the temporary ID of the AIoT device 1102.

At 1214 (e.g., step 7), the AIoT reader 1104 communicates (e.g., transmits, sends, outputs, forwards) the command response with the temporary ID to the AIoTF 1106.

When the AIoTF 1106 sends out a new group inventory request with a fresh or new correlation ID, all AIoT devices of the group (as well as the AIoTF 1106 for all group members) will individually compute a new temporary ID.

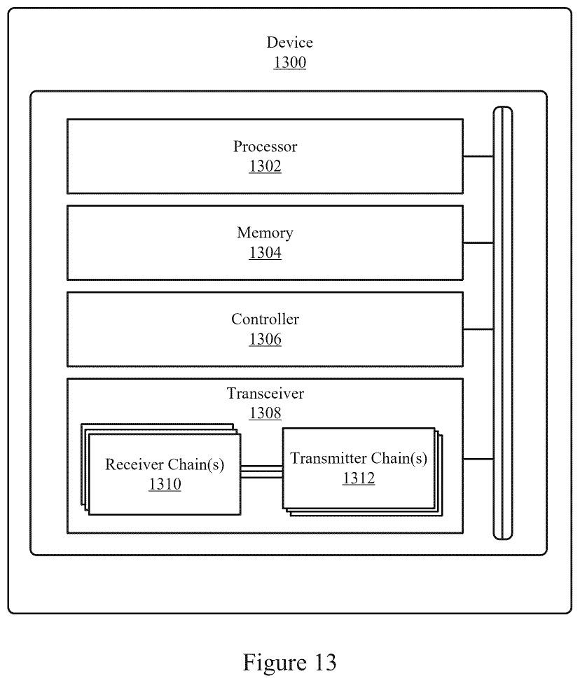

FIG. 13 illustrates an example of a device 1300 in accordance with aspects of the present disclosure. The device 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces. The device 1300 may be a low power device (e.g., an AIoT device), a UE, or the like.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the device 1300 to perform various functions of the present disclosure.

The memory 1304 may include volatile or non-volatile memory. The memory 1304 may store computer-readable, computer-executable code including instructions when executed by the processor 1302 cause the device 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the device 1300 to perform one or more of the functions described herein (e.g., executing, by the processor 1302, instructions stored in the memory 1304). For example, the processor 1302 may support wireless communication at the device 1300 in accordance with examples as disclosed herein. The device 1300 may be configured to or operable to support a means for receiving a group inventory request that includes a group ID and a correlation ID; generating a temporary ID for the device based at least in part on the correlation ID and an individual ID of the device; and transmitting an inventory response that includes the temporary ID for the device and the correlation ID.

Additionally, the device 1300 may be configured to support any one or combination of further including detecting that the group ID matches a common part of the individual ID of the device, where the generating the temporary ID further comprises generating the temporary ID based at least in part on the common part of the individual ID matching the group ID; where generating the temporary ID further comprises generating the temporary ID based at least in part on a shared security key and based at least in part on inputting the individual ID of the device and the correlation ID to a hash-based message authentication code function; where generating the temporary ID further comprises generating the temporary ID based at least in part on a shared security key and based at least in part on inputting the individual ID of the device, the correlation ID, and a common part of the individual ID of the device to a hash-based message authentication code function; where the shared security key is shared between the device and an AIoTF that initiated the group inventory request; further including storing the temporary ID for future command paging messages; where, receiving the group inventory request further comprises receiving the group inventory request from an AIoT reader, and transmitting the inventory response further comprises transmitting the inventory response to the AIoT reader; further including: receiving a command request that includes a second temporary ID; performing, based at least in part on the second temporary ID matching the temporary ID of the device, a command indicated by the command request; and transmitting a command response message that includes the second temporary ID; where the device comprises an AIoT device.

Additionally, or alternatively, the device 1300 may be configured to or operable to support a means for receiving a command request that includes a temporary ID; performing, based at least in part on the received temporary ID matching a temporary ID of the device, a command indicated by the command request; and transmitting a command response message that includes the temporary ID.

Additionally, the device 1300 may be configured to support any one or combination of where the temporary ID of the device comprises a temporary ID stored at the device; where, receiving the command request further comprises receiving the command request from an AIoT reader, and transmitting the command response further including transmitting the command response to the AIoT reader; where the device comprises an AIoT device.

Additionally, or alternatively, the device 1300 may support at least one memory (e.g., the memory 1304) and at least one processor (e.g., the processor 1302) coupled with the at least one memory and configured to cause the device to: receive a group inventory request that includes a group ID and a correlation ID; generate a temporary ID for the device based at least in part on the correlation ID and an individual ID of the device; and transmit an inventory response that includes the temporary ID for the device and the correlation ID.

Additionally, the device 1300 may be configured to support any one or combination of the at least one processor is configured cause the device to detect that the group ID matches a common part of the individual ID of the device, where to generate the temporary ID, the at least one processor is further configured to cause the device to generate the temporary ID based at least in part on the common part of the individual ID matching the group ID; where to generate the temporary ID, the at least one processor is further configured to cause the device to generate the temporary ID based at least in part on a shared security key and based at least in part on inputting the individual ID of the device and the correlation ID to a hash-based message authentication code function; where to generate the temporary ID, the at least one processor is further configured to cause the device to generate the temporary ID based at least in part on a shared security key and based at least in part on inputting the individual ID of the device, the correlation ID, and a common part of the individual ID of the device to a hash-based message authentication code function; where the shared security key is shared between the device and an AIoTF that initiated the group inventory request; where the at least one processor is further configured to cause the device to store the temporary ID for future command paging messages; where, to receive the group inventory request, the at least one processor is further configured to cause the device to receive the group inventory request from an AIoT reader, and to transmit the inventory response, the at least one processor is further configured to cause the device to transmit the inventory response to the AIoT reader; where the at least one processor is further configured to cause the device to: receive a command request that includes a second temporary ID; perform, based at least in part on the second temporary ID matching the temporary ID of the device, a command indicated by the command request; and transmit a command response message that includes the second temporary ID; where the device comprises an AIoT device.

Additionally, or alternatively, the device 1300 may support at least one memory (e.g., the memory 1304) and at least one processor (e.g., the processor 1302) coupled with the at least one memory and configured to cause the device to: receive a command request that includes a temporary ID; perform, based at least in part on the received temporary ID matching a temporary ID of the device, a command indicated by the command request; and transmit a command response message that includes the temporary ID.

Additionally, the device 1300 may be configured to support any one or combination of where the temporary ID of the device comprises a temporary ID stored at the device; where, to receive the command request, the at least one processor is further configured to cause the device to receive the command request from an AIoT reader, and to transmit the command response, the at least one processor is further configured to cause the device to transmit the command response to the AIoT reader; where the device comprises an AIoT device.

The controller 1306 may manage input and output signals for the device 1300. The controller 1306 may also manage peripherals not integrated into the device 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the device 1300 may include at least one transceiver 1308. In some other implementations, the device 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

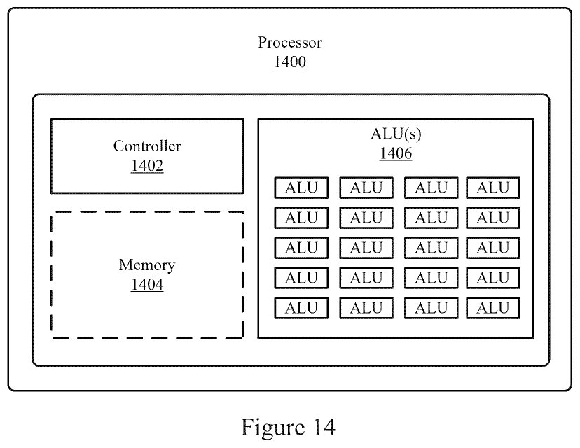

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to: receive a group inventory request that includes a group ID and a correlation ID; generate a temporary ID for the processor based at least in part on the correlation ID and an individual ID of the processor; and transmit an inventory response that includes the temporary ID for the processor and the correlation ID.

Additionally, the processor 1400 may be configured to or operable to support any one or combination of where the at least one controller is further configured to cause the processor to detect that the group ID matches a common part of the individual ID of the processor, where to generate the temporary ID, the at least one controller is further configured to cause the processor to generate the temporary ID based at least in part on the common part of the individual ID matching the group ID; where to generate the temporary ID, the at least one controller is further configured to cause the processor to generate the temporary ID based at least in part on a shared security key and based at least in part on inputting the individual ID of the processor and the correlation ID to a hash-based message authentication code function; where to generate the temporary ID, the at least one controller is further configured to cause the processor to generate the temporary ID based at least in part on a shared security key and based at least in part on inputting the individual ID of the processor, the correlation ID, and a common part of the individual ID of the processor to a hash-based message authentication code function; where the shared security key is shared between the processor and an AIoTF that initiated the group inventory request; where the at least one controller is further configured to cause the processor to store the temporary ID for future command paging messages; where, to receive the group inventory request, the at least one controller is further configured to cause the processor to receive the group inventory request from an AIoT reader, and to transmit the inventory response, the at least one controller is further configured to cause the processor to transmit the inventory response to the AIoT reader; where the at least one controller is further configured to cause the processor to: receive a command request that includes a second temporary ID; perform, based at least in part on the second temporary ID matching the temporary ID of the processor, a command indicated by the command request; and transmit a command response message that includes the second temporary ID; where the processor is included in an AIoT device.

The processor 1400 may be configured to or operable to support at least one controller (e.g., the controller 1402) coupled with at least one memory (e.g., the memory 1404) and configured to cause the processor to: receive a command request that includes a temporary ID; perform, based at least in part on the received temporary ID matching a temporary ID of the processor, a command indicated by the command request; and transmit a command response message that includes the temporary ID.

Additionally, the processor 1400 may be configured to or operable to support any one or combination of where the temporary ID of the processor comprises a temporary ID stored by the processor; where, to receive the command request, the at least one controller is further configured to cause the processor to receive the command request from an AIoT reader, and to transmit the command response, the at least one controller is further configured to cause the processor to transmit the command response to the AIoT reader; where the processor is included in an AIoT device.

The processor 1400 may be configured to or operable to support at least one controller (e.g., the controller 1402) coupled with at least one memory (e.g., the memory 1404) and configured to cause the processor to: generate, for each of one or more devices, an expected temporary ID for the device based at least in part on a correlation ID and an individual ID of the device; transmit a group inventory request that includes a group ID and a correlation ID; and receive an inventory response that includes a temporary ID for the device and the correlation ID.

Additionally, the processor 1400 may be configured to or operable to support any one or combination of where the at least one controller is further configured to cause the processor to detect that an individual device of the one or more devices responded to the group inventory request based at least in part on a received temporary ID matching the expected temporary ID for the individual device; where the at least one controller is further configured to cause the processor to, for each of the one or more devices, generate the expected temporary ID for the device based at least in part on a common part of the individual ID matching the group ID; where for each of the one or more devices, to generate the expected temporary ID, the at least one controller is further configured to cause the processor to generate the expected temporary ID based at least in part on a shared security key and based at least in part on inputting the individual ID of the device and the correlation ID to a hash-based message authentication code function; where for each of the one or more devices, to generate the expected temporary ID, the at least one controller is further configured to cause the processor to generate the expected temporary ID based at least in part on a shared security key and based at least in part on inputting the individual ID of the device, and the correlation ID, and a common part of the individual ID of the device matching the group ID to a hash-based message authentication code function; where different shared security keys are shared between the processor and different ones of the one or more devices; where, to transmit the group inventory request, the at least one controller is further configured to cause the processor to transmit the group inventory request to an AIoT reader, and to receive the inventory response, the at least one controller is further configured to cause the processor to receive the inventory response from the AIoT reader; where the at least one controller is further configured to cause the processor to: select a temporary ID of one device of the one or more devices; transmit a command request that includes the temporary ID of the one device; and receive a command response message that includes the temporary ID of the one device; where each of the one or more devices comprises an AIoT device; where the processor is included in an AIoTF.

The processor 1400 may be configured to or operable to support at least one controller (e.g., the controller 1402) coupled with at least one memory (e.g., the memory 1404) and configured to cause the processor to: select a temporary ID of one device of multiple devices; transmit a command request that includes the temporary ID; and receive a command response message that includes the temporary ID.

Additionally, the processor 1400 may be configured to or operable to support any one or combination of where the temporary ID of the device comprises a temporary ID received for the one device; where, to transmit the command request, the at least one controller is further configured to cause the processor to transmit the command request to an AIoT reader, and to receive the command response, the at least one controller is further configured to cause the processor to receive the command response from the AIoT reader; where the one device comprises an AIoT device.

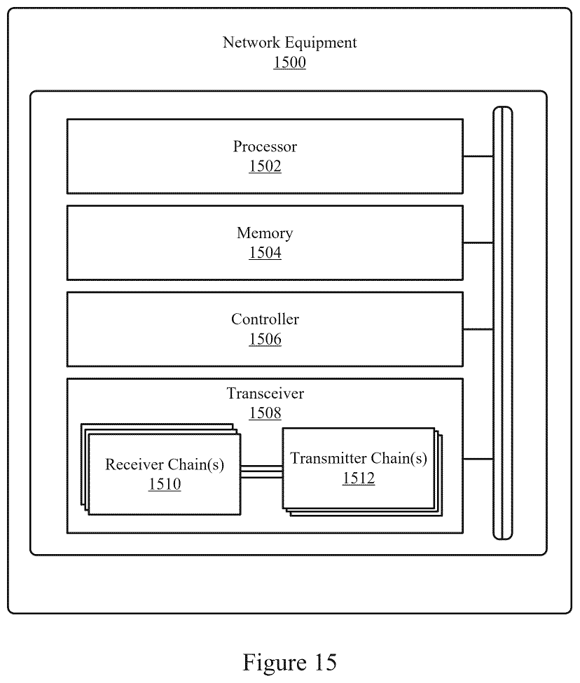

FIG. 15 illustrates an example of a NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein. The NE 1500 may be configured to support a means for generating, for each of one or more devices, an expected temporary ID for the device based at least in part on a correlation ID and an individual ID of the device; transmitting a group inventory request that includes a group ID and a correlation ID; and receiving an inventory response that includes a temporary ID for the device and the correlation ID.

Additionally, the NE 1500 may be configured to support any one or combination of further including detecting that an individual device of the one or more devices responded to the group inventory request based at least in part on a received temporary ID matching the expected temporary ID for the individual device; further including, for each of the one or more devices, generating the expected temporary ID for the device based at least in part on a common part of the individual ID matching the group ID; where for each of the one or more devices, the generating the expected temporary ID further comprises generating the expected temporary ID based at least in part on a shared security key and based at least in part on inputting the individual ID of the device and the correlation ID to a hash-based message authentication code function; where for each of the one or more devices, the generating the expected temporary ID further comprises generating the expected temporary ID based at least in part on a shared security key and based at least in part on inputting the individual ID of the device, and the correlation ID, and a common part of the individual ID of the device matching the group ID to a hash-based message authentication code function; where different shared security keys are shared between the NE and different ones of the one or more devices; where, transmitting the group inventory request further comprises transmitting the group inventory request to an AIoT reader, and receiving the inventory response further comprises receiving the inventory response from the AIoT reader; further including: selecting a temporary ID of one device of the one or more devices; transmitting a command request that includes the temporary ID of the one device; and receiving a command response message that includes the temporary ID of the one device; where each of the one or more devices comprises an AIoT device; where the NE comprises an AIoTF.

The NE 1500 may be configured to support a means for selecting a temporary ID of one device of multiple devices; transmitting a command request that includes the temporary ID; and receiving a command response message that includes the temporary ID.

Additionally, the NE 1500 may be configured to support any one or combination of where the temporary ID of the device comprises a temporary ID received for the one device; where, transmitting the command request further comprises transmitting the command request to an AIoT reader, and receiving the command response further comprises receiving the command response from the AIoT reader; where the one device comprises an AIoT device.

Additionally, or alternatively, the NE 1500 may support at least one memory (e.g., the memory 1504) and at least one processor (e.g., the processor 1502) coupled with the at least one memory and configured to cause the NE to: generate, for each of one or more devices, an expected temporary ID for the device based at least in part on a correlation ID and an individual ID of the device; transmit a group inventory request that includes a group ID and a correlation ID; and receive an inventory response that includes a temporary ID for the device and the correlation ID.

Additionally, the NE 1500 may be configured to support any one or combination of where the at least one processor is further configured to cause the NE to detect that an individual device of the one or more devices responded to the group inventory request based at least in part on a received temporary ID matching the expected temporary ID for the individual device; where the at least one processor is further configured to cause the NE to, for each of the one or more devices, generate the expected temporary ID for the device based at least in part on a common part of the individual ID matching the group ID; where for each of the one or more devices, to generate the expected temporary ID, the at least one processor is further configured to cause the NE to generate the expected temporary ID based at least in part on a shared security key and based at least in part on inputting the individual ID of the device and the correlation ID to a hash-based message authentication code function; where for each of the one or more devices, to generate the expected temporary ID, the at least one processor is further configured to cause the NE to generate the expected temporary ID based at least in part on a shared security key and based at least in part on inputting the individual ID of the device, and the correlation ID, and a common part of the individual ID of the device matching the group ID to a hash-based message authentication code function; where different shared security keys are shared between the NE and different ones of the one or more devices; where, to transmit the group inventory request, the at least one processor is further configured to cause the NE to transmit the group inventory request to an AIoT reader, and to receive the inventory response, the at least one processor is further configured to cause the NE to receive the inventory response from the AIoT reader; where the at least one processor is further configured to cause the NE to: select a temporary ID of one device of the one or more devices; transmit a command request that includes the temporary ID of the one device; and receive a command response message that includes the temporary ID of the one device; where each of the one or more devices comprises an AIoT device; where the NE comprises an AIoTF.

Additionally, or alternatively, the NE 1500 may support at least one memory (e.g., the memory 1504) and at least one processor (e.g., the processor 1502) coupled with the at least one memory and configured to cause the NE to: select a temporary ID of one device of multiple devices; transmit a command request that includes the temporary ID; and receive a command response message that includes the temporary ID.

Additionally, the NE 1500 may be configured to support any one or combination of where the temporary ID of the device comprises a temporary ID received for the one device; where, to transmit the command request, the at least one processor is further configured to cause the NE to transmit the command request to an AIoT reader, and to receive the command response, the at least one processor is further configured to cause the NE to receive the command response from the AIoT reader; where the one device comprises an AIoT device.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

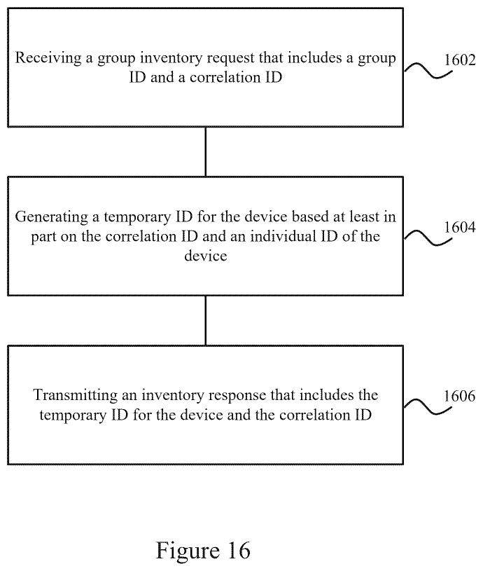

FIG. 16 illustrates a flowchart of a method in accordance with aspects of the present disclosure. The operations of the method may be implemented by a device as described herein. In some implementations, the device may execute a set of instructions to control the function elements of the device to perform the described functions.

At 1602, the method may include receiving a group inventory request that includes a group ID and a correlation ID. The operations of 1602 may be performed in accordance with examples as described herein. In some implementations, aspects of the operations of 1602 may be performed by a device as described with reference to FIG. 13.

At 1604, the method may include generating a temporary ID for the device based at least in part on the correlation ID and an individual ID of the device. The operations of 1604 may be performed in accordance with examples as described herein. In some implementations, aspects of the operations of 1604 may be performed by a device as described with reference to FIG. 13.

At 1606, the method may include transmitting an inventory response that includes the temporary ID for the device and the correlation ID. The operations of 1606 may be performed in accordance with examples as described herein. In some implementations, aspects of the operations of 1606 may be performed a device as described with reference to FIG. 13.

It should be noted that the method described herein describes a possible implementation, and that the operations and the steps may be rearranged or otherwise modified and that other implementations are possible.

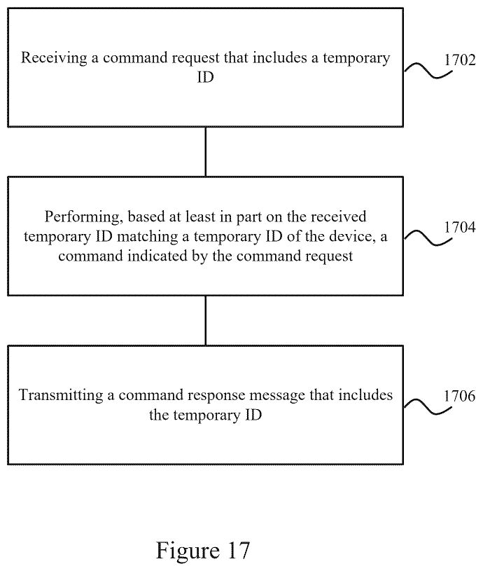

FIG. 17 illustrates a flowchart of a method in accordance with aspects of the present disclosure. The operations of the method may be implemented by a device as described herein. In some implementations, the device may execute a set of instructions to control the function elements of the device to perform the described functions.

At 1702, the method may include receiving a command request that includes a temporary ID. The operations of 1702 may be performed in accordance with examples as described herein. In some implementations, aspects of the operations of 1702 may be performed by a device as described with reference to FIG. 13.

At 1704, the method may include performing, based at least in part on the received temporary ID matching a temporary ID of the device, a command indicated by the command request. The operations of 1704 may be performed in accordance with examples as described herein. In some implementations, aspects of the operations of 1704 may be performed by a device as described with reference to FIG. 13.

At 1706, the method may include transmitting a command response message that includes the temporary ID. The operations of 1706 may be performed in accordance with examples as described herein. In some implementations, aspects of the operations of 1706 may be performed a device as described with reference to FIG. 13.

It should be noted that the method described herein describes a possible implementation, and that the operations and the steps may be rearranged or otherwise modified and that other implementations are possible.

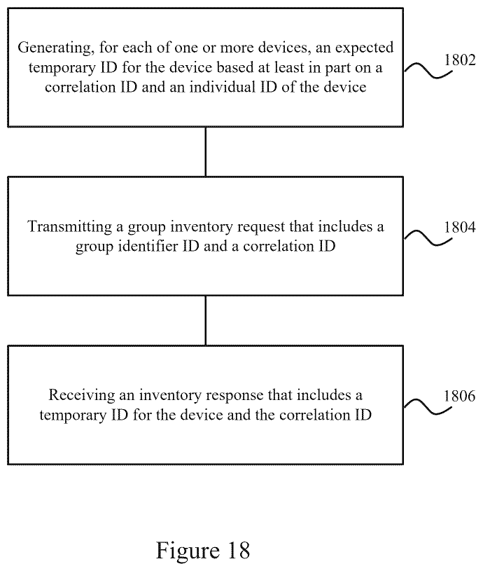

FIG. 18 illustrates a flowchart of a method in accordance with aspects of the present disclosure. The operations of the method may be implemented by a NE as described herein. In some implementations, the NE may execute a set of instructions to control the function elements of the NE to perform the described functions.

At 1802, the method may include generating, for each of one or more devices, an expected temporary ID for the device based at least in part on a correlation ID and an individual ID of the device. The operations of 1802 may be performed in accordance with examples as described herein. In some implementations, aspects of the operations of 1802 may be performed by a NE as described with reference to FIG. 15.

At 1804, the method may include transmitting a group inventory request that includes a group identifier ID and a correlation ID. The operations of 1804 may be performed in accordance with examples as described herein. In some implementations, aspects of the operations of 1804 may be performed by a NE as described with reference to FIG. 15.

At 1806, the method may include receiving an inventory response that includes a temporary ID for the device and the correlation ID. The operations of 1806 may be performed in accordance with examples as described herein. In some implementations, aspects of the operations of 1806 may be performed a NE as described with reference to FIG. 15.

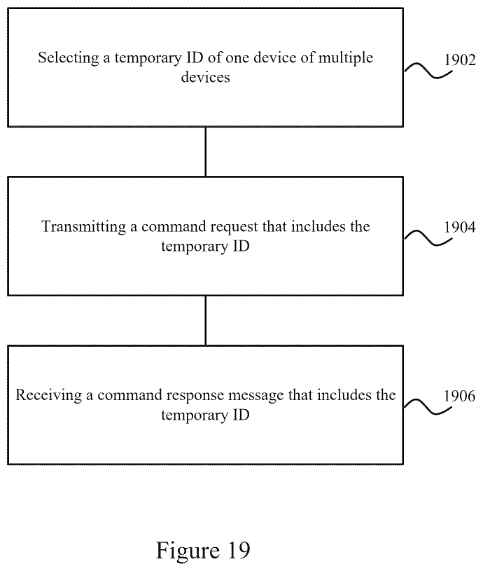

FIG. 19 illustrates a flowchart of a method in accordance with aspects of the present disclosure. The operations of the method may be implemented by a NE as described herein. In some implementations, the NE may execute a set of instructions to control the function elements of the NE to perform the described functions.

At 1902, the method may include selecting a temporary ID of one device of multiple devices. The operations of 1902 may be performed in accordance with examples as described herein. In some implementations, aspects of the operations of 1902 may be performed by a NE as described with reference to FIG. 15.

At 1904, the method may include transmitting a command request that includes the temporary ID. The operations of 1904 may be performed in accordance with examples as described herein. In some implementations, aspects of the operations of 1904 may be performed by a NE as described with reference to FIG. 15.

At 1906, the method may include receiving a command response message that includes the temporary ID. The operations of 1906 may be performed in accordance with examples as described herein. In some implementations, aspects of the operations of 1906 may be performed a NE as described with reference to FIG. 15.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device for wireless communication, comprising:
at least one memory; and
at least one processor coupled with the at least one memory and operable to cause the device to:
receive a group inventory request that includes a group identifier (ID) and a correlation ID;
generate a temporary ID for the device based at least in part on the correlation ID and an individual ID of the device; and
transmit an inventory response that includes the temporary ID for the device and the correlation ID.

2. The device of claim 1, wherein the at least one processor is further configured to cause the device to detect that the group ID matches a common part of the individual ID of the device, wherein to generate the temporary ID, the at least one processor is further configured to cause the device to generate the temporary ID based at least in part on the common part of the individual ID matching the group ID.

3. The device of claim 1, wherein to generate the temporary ID, the at least one processor is further configured to cause the device to generate the temporary ID based at least in part on a shared security key and based at least in part on inputting the individual ID of the device and the correlation ID to a hash-based message authentication code function.

4. The device of claim 1, wherein to generate the temporary ID, the at least one processor is further configured to cause the device to generate the temporary ID based at least in part on a shared security key and based at least in part on inputting the individual ID of the device, the correlation ID, and a common part of the individual ID of the device to a hash-based message authentication code function.

5. The device of claim 3, wherein the shared security key is shared between the device and an Ambient Internet-of-Things (AIoT) function (AIoTF) that initiated the group inventory request.

6. The device of claim 1, wherein the at least one processor is further configured to cause the device to store the temporary ID for future command paging messages.

7. The device of claim 1, wherein,
to receive the group inventory request, the at least one processor is further configured to cause the device to receive the group inventory request from an Ambient Internet-of-Things (AIoT) reader, and
to transmit the inventory response, the at least one processor is further configured to cause the device to transmit the inventory response to the AIoT reader.

8. The device of claim 1, wherein the at least one processor is further configured to cause the device to:
receive a command request that includes a second temporary ID;
perform, based at least in part on the second temporary ID matching the temporary ID of the device, a command indicated by the command request; and
transmit a command response message that includes the second temporary ID.

9. The device of claim 1, wherein the device comprises an Ambient Internet-of-Things (AIoT) device.

10. A network equipment (NE) for wireless communication, comprising:
at least one memory; and
at least one processor coupled with the at least one memory and operable to cause the NE to:
generate, for each of one or more devices, an expected temporary ID for the device based at least in part on a correlation ID and an individual ID of the device;
transmit a group inventory request that includes a group identifier (ID) and a correlation ID; and
receive an inventory response that includes a temporary ID for the device and the correlation ID.

11. The NE of claim 10, wherein the at least one processor is further configured to cause the NE to detect that an individual device of the one or more devices responded to the group inventory request based at least in part on a received temporary ID matching the expected temporary ID for the individual device.

12. The NE of claim 10, wherein the at least one processor is further configured to cause the NE to, for each of the one or more devices, generate the expected temporary ID for the device based at least in part on a common part of the individual ID matching the group ID.

13. The NE of claim 10, wherein for each of the one or more devices, to generate the expected temporary ID, the at least one processor is further configured to cause the NE to generate the expected temporary ID based at least in part on a shared security key and based at least in part on inputting the individual ID of the device and the correlation ID to a hash-based message authentication code function.

14. The NE of claim 10, wherein for each of the one or more devices, to generate the expected temporary ID, the at least one processor is further configured to cause the NE to generate the expected temporary ID based at least in part on a shared security key and based at least in part on inputting the individual ID of the device, and the correlation ID, and a common part of the individual ID of the device matching the group ID to a hash-based message authentication code function.

15. The NE of claim 13, wherein different shared security keys are shared between the NE and different ones of the one or more devices.

16. The NE of claim 10, wherein,
to transmit the group inventory request, the at least one processor is further configured to cause the NE to transmit the group inventory request to an Ambient Internet-of-Things (AIoT) reader, and
to receive the inventory response, the at least one processor is further configured to cause the NE to receive the inventory response from the AIoT reader.

17. The NE of claim 10, wherein the at least one processor is further configured to cause the NE to:
select a temporary ID of one device of the one or more devices;
transmit a command request that includes the temporary ID of the one device; and
receive a command response message that includes the temporary ID of the one device.

18. The NE of claim 10, wherein each of the one or more devices comprises an Ambient Internet-of-Things (AIoT) device and the NE comprises an Ambient Internet-of-Things (AIoT) function (AIoTF).

19. A method performed by a device, the method comprising:
receiving a group inventory request that includes a group identifier (ID) and a correlation ID;
generating a temporary ID for the device based at least in part on the correlation ID and an individual ID of the device; and
transmitting an inventory response that includes the temporary ID for the device and the correlation ID.

20. A method performed by a network equipment (NE), the method comprising:
generating, for each of one or more devices, an expected temporary identifier (ID) for the device based at least in part on a correlation ID and an individual ID of the device;
transmitting a group inventory request that includes a group identifier ID and a correlation ID; and
receiving an inventory response that includes a temporary ID for the device and the correlation ID.
